(19) United States
(12) Patent Application Publication
(10) Pub. No.: US 2024/0184636 A1
(43) Pub. Date: Jun. 6, 2024

(54) GENERATING REPRESENTATIVE SAMPLING DATA FOR BIG DATA ANALYTICS

(71) Applicant: International Business Machines Corporation, Armonk, NY (US)

(72) Inventors: Ye Fan, Xian (CN); Chong Liu, Xian (CN); Yang Yang, Xian (CN); Juan Wu, Xi'an (CN); Xu Lu, Xi'an (CN); Jin Xu, Xian (CN)

(21) Appl. No.: 18/060,618

(22) Filed: Dec. 1, 2022

(51) Int. Cl. G06F 9/50; G06F 3/06

(52) U.S. Cl. CPC G06F 9/5061; G06F 3/0604; G06F 3/064; G06F 3/0673

(57) ABSTRACT

In an approach, a processor divides a set of data into at least two smaller data blocks. For each of the at least two smaller data blocks, a processor calculates an original value for a data distribution of a respective smaller data block, runs at least two different sampling methods against the respective smaller data block to produce at least two different sets of sample data for the respective smaller data block, calculates respective sampling values for the data distribution of each set of sample data, and selects a set of sample data of the at least two different sets of sample data that has the respective sampling value that is closest to the original value for the respective smaller data block. A processor merges each selected set of sample data for each smaller data block to form a final set of sample data.

### BACKGROUND OF THE INVENTION

The present invention relates generally to the field of data analytics, and more particularly to generating representative sampling data for big data analytics.

Big data refers to data sets that are too large or complex to be dealt with by traditional data-processing application software. Data with many fields (rows) offer greater statistical power, while data with higher complexity (more attributes or columns) may lead to a higher false discovery rate. Big data analysis challenges include capturing data, data storage, data analysis, search, sharing, transfer, visualization, querying, updating, information privacy, and data source. Big data was originally associated with three key concepts: volume, variety, and velocity. The analysis of big data presents challenges in sampling, and thus previously allowing for only observations and sampling. Sampling can be a good approach to make big data become small, but there are many different sampling methods with different options that produce different results. Some methods are not representative of the original data, and thus shouldn't be used for data analytics. Thus a fourth concept, veracity, refers to the quality or insightfulness of the data. Without sufficient investment in expertise for big data veracity, the volume and variety of data can produce costs and risks that exceed an organization's capacity to create and capture value from big data.

### SUMMARY

Aspects of an embodiment of the present invention disclose a method, computer program product, and computer system for generating representative sampling data for big data analytics. A processor divides a set of data into at least two smaller data blocks. For each of the at least two smaller data blocks, a processor calculates an original value for a data distribution of a respective smaller data block, runs at least two different sampling methods against the respective smaller data block to produce at least two different sets of sample data for the respective smaller data block, calculates respective sampling values for the data distribution of each set of sample data of the at least two different sets of sample data, and selects a set of sample data of the at least two different sets of sample data that has the respective sampling value that is closest to the original value for the respective smaller data block. A processor merges each selected set of sample data for each smaller data block to form a final set of sample data.

### BRIEF DESCRIPTION OF THE DRAWINGS

FIG. 1 is a functional block diagram illustrating a distributed data processing environment, in accordance with an embodiment of the present invention.

FIG. 2 is a flowchart depicting operational steps of a big data sampling program, for generating representative sampling data for big data analytics, running within distributed data processing environments of FIG. 1, in accordance with an embodiment of the present invention.

FIG. 3 is a block diagram illustrating how an example big data set is processed by the big data sampling program, in accordance with an embodiment of the present invention.

FIG. 4 depicts a block diagram of components of the distributed data processing environment of FIG. 1, for running the sampling data generator program, in accordance with an embodiment of the present invention.

### DETAILED DESCRIPTION

Embodiments of the present invention recognize that sampling can be a good approach to make big data become small, but there are many different sampling methods with different options that produce different results. Some methods are not representative of the original data, and thus shouldn't be used for data analytics. Thus, embodiments of the present invention recognize the need for a smarter way to generate a representative sampling of data.

Embodiments of the present invention provide a system and method for generating the most representative sample data from an original data set and speeding up the generation of this sample data by paralleling the sampling process. Embodiments of the present invention leverage a distributed computing environment to enable breaking a dataset into smaller blocks, performing a sampling of each smaller block, and then merging the results together in the end. To ensure representative sampling data is generated, embodiments of the present invention run various sampling methods against each smaller data block and select the most representative sampling result for each to be combined to form the final data sample.

Embodiments of the present invention assume that (1) when sampling big data, the closer a data property (e.g., data distribution) of the sample data compares with the data property of the original data, the more representative the sample data is and (2) by selecting the most representative sample data from each smaller block, the final sample data is the most representative sample data of the original data.

Implementation of embodiments of the invention may take a variety of forms, and exemplary implementation details are discussed subsequently with reference to the Figures.

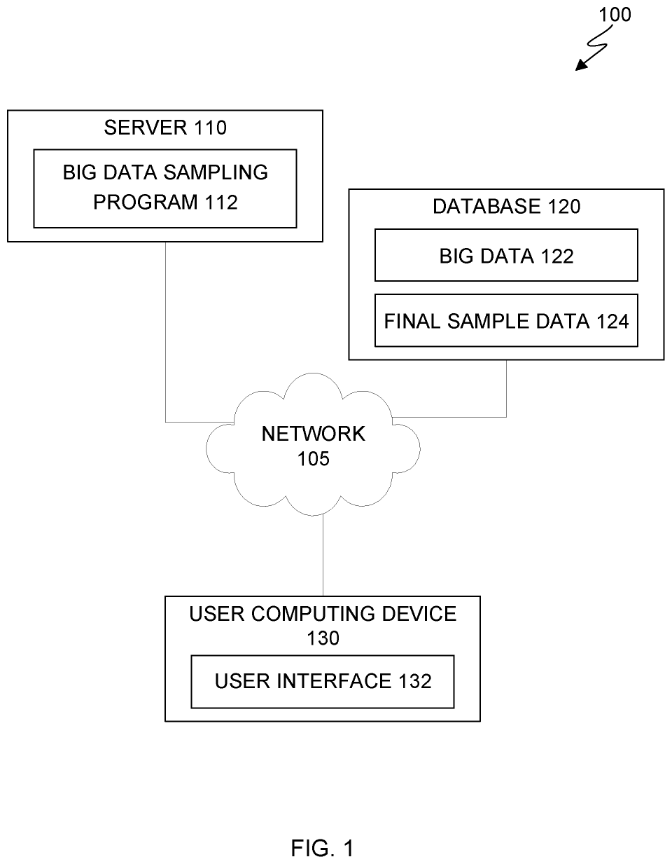

FIG. 1 is a functional block diagram illustrating a distributed data processing environment, generally designated 100, in accordance with one embodiment of the present invention. The term “distributed,” as used herein, describes a computer system that includes multiple, physically distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes server 110, database 120, and user computing device 130, interconnected over network 105. Network 105 can be, for example, a telecommunications network, a local area network (LAN), a wide area network (WAN), such as the Internet, or a combination of the three, and can include wired, wireless, or fiber optic connections. Network 105 can include one or more wired and/or wireless networks capable of receiving and transmitting data, voice, and/or video signals, including multimedia signals that include voice, data, and video information. In general, network 105 can be any combination of connections and protocols that will support communications between server 110, database 120, user computing device 130, and other computing devices (not shown) within distributed data processing environment 100.

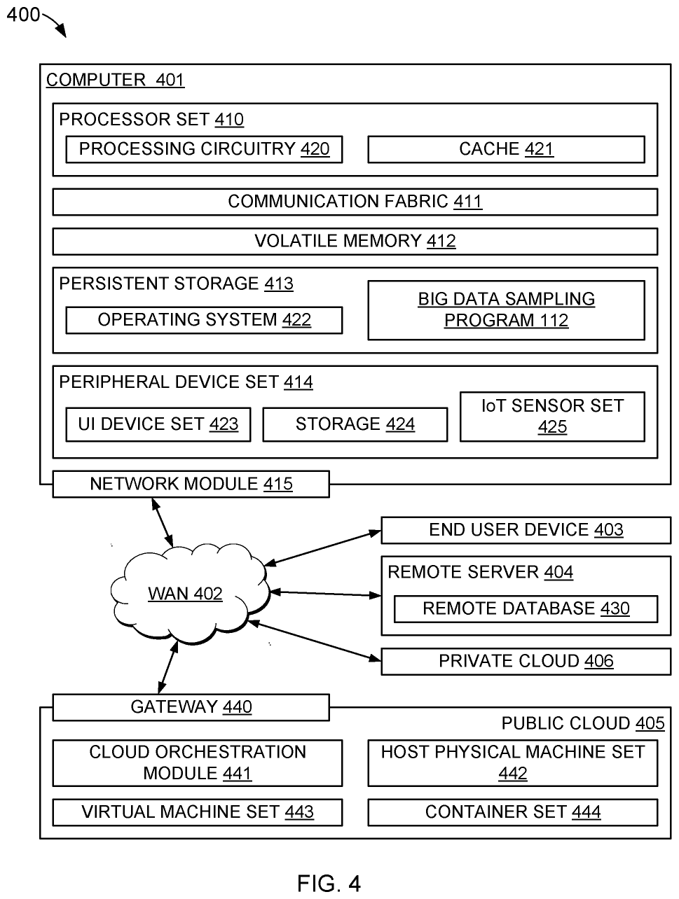

Server 110 can be a standalone computing device, a management server, a web server, a mobile computing device, or any other electronic device or computing system capable of receiving, sending, and processing data. In other embodiments, server 110 can represent a server computing system utilizing multiple computers as a server system, such as in a cloud computing environment. In another embodiment, server 110 can be a laptop computer, a tablet computer, a netbook computer, a personal computer (PC), a desktop computer, a personal digital assistant (PDA), a smart phone, or any programmable electronic device capable of communicating with database 120, user computing device 130, and other computing devices (not shown) within distributed data processing environment 100 via network 105. In another embodiment, server 110 represents a computing system utilizing clustered computers and components (e.g., database server computers, application server computers, etc.) that act as a single pool of seamless resources when accessed within distributed data processing environment 100. Server 110 includes big data sampling program 112. Server 110 may include internal and external hardware components, as depicted and described in further detail with respect to FIG. 4.

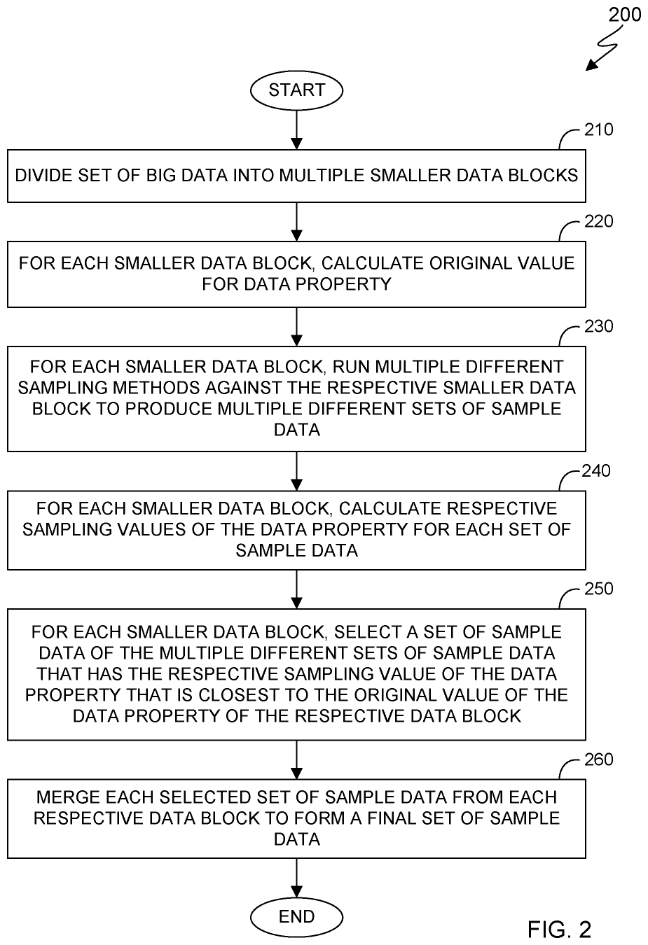

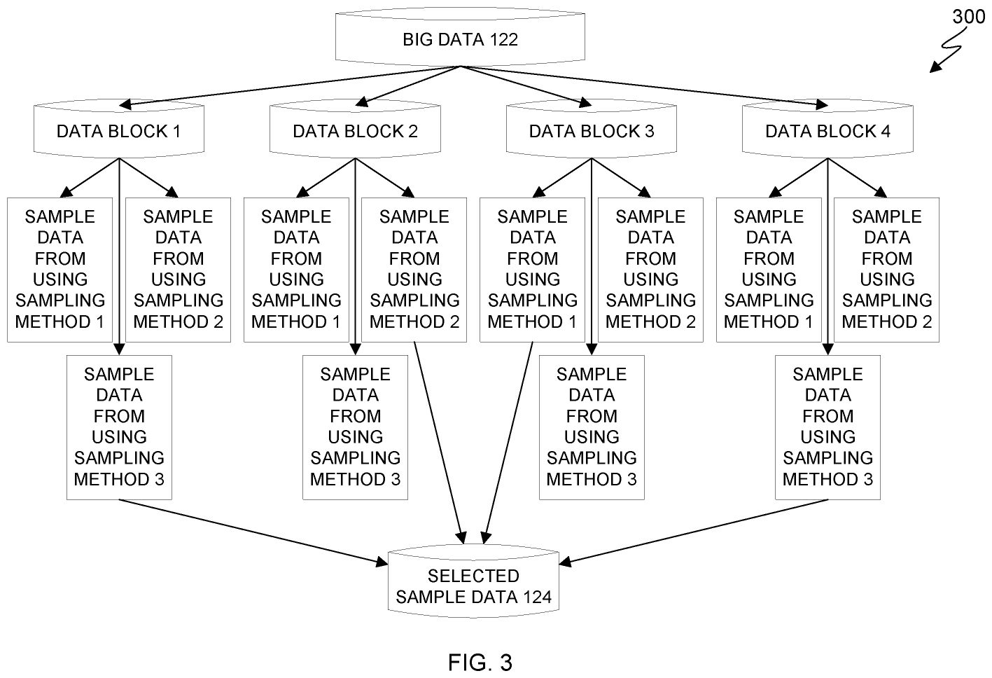

Big data sampling program 112 utilizes a distributed computing environment (not shown) to generate representative sampling data for big data analytics. Server 110 may be part of the distributed computing environment or the distributed computing environment may be another component of FIG. 1 that is in communication with server 110 via network 105. In the depicted embodiment, big data sampling program 112 is a standalone program. In another embodiment, big data sampling program 112 may be integrated into another software product, e.g., a data analytics package. Big data sampling program 112 is depicted and described in further detail with respect to FIGS. 2 and 3.

Database 120 operates as a repository for data received, used, and/or output by big data sampling program 112. Data received, used, and/or generated may include, but is not limited to, set of big data received (e.g., big data 122), final sample data generated by data sampling program 112 (e.g., final sample data 124) to be sample data that is representative of the set of big data, and any other data received, used, and/or output by big data sampling program 112. Database 120 can be implemented with any type of storage device capable of storing data and configuration files that can be accessed and utilized by server 110, such as a hard disk drive, a database server, or a flash memory. In an embodiment, database 120 is accessed by big data sampling program 112 to store and/or to access the data. In the depicted embodiment, database 120 is a separate entity. In another embodiment, database 120 may reside on another computing device, server, cloud server, or spread (i.e., distributed) across multiple devices elsewhere (not shown) within distributed data processing environment 100, provided that big data sampling program 112 has access to database 120.

User computing device 130 operates as a computing device associated with a user on which the user can interact with big data sampling program 112 through an application user interface (not shown). In the depicted embodiment, user computing device 130 includes user interface 132. In an embodiment, user computing device 130 can be a laptop computer, a tablet computer, a smart phone, a smart watch, an e-reader, smart glasses, wearable computer, or any programmable electronic device capable of communicating with various components and devices within distributed data processing environment 100, via network 105. In general, user computing device 130 represents one or more programmable electronic devices or combination of programmable electronic devices capable of executing machine readable program instructions and communicating with other computing devices (not shown) within distributed data processing environment 100 via a network, such as network 105.

User interface 132 provides an interface between big data sampling program 112 on server 110 and a user of user computing device 130. In one embodiment, user interface 132 is a mobile application software for big data sampling program 112 enabling a user view and/or manage output of big data sampling program 112. Mobile application software, or an “app,” is a computer program designed to run on smart phones, tablet computers, and other mobile computing devices. In one embodiment, user interface 132 may be a graphical user interface (GUI) or a web user interface (WUI) that can display text, documents, web browser windows, user options, application interfaces, and instructions for operation, and include the information (such as graphic, text, and sound) that a program presents to a user and the control sequences the user employs to control the program. User interface 132 enables a user to select a set of big data and initiate big data sampling program 112 to process that set of big data. User interface 132 enables a user to pre-configure and/or select a set of sampling methods to be run during big data sampling program 112.

FIG. 2 is a flowchart 200 depicting operational steps of big data sampling program 112, generating representative sampling data for big data analytics, in accordance with an embodiment of the present invention. It should be appreciated that the process depicted in FIG. 2 illustrates one possible iteration of big data sampling program 112, which can be initiated by a user of user computing device 130 or upon a set of big data being stored in database 120.

In step 210, big data sampling program 112 divides the set of big data into multiple smaller data blocks. A set of big data can be defined as a set of data that is too large or complex to be dealt with by traditional data-processing application software, e.g., a dataset with 100 million records. In an embodiment, responsive to either a user of user computing device 130 initiating big data sampling program 112 by selecting a set of dig data for processing or a new set of big data being stored in database 120, big data sampling program 112 divides the set of big data into multiple (i.e., at least two) smaller data blocks, in which the smaller data blocks are each smaller than the original set of big data and can be of equal size or different sizes based on available computing resources. In an embodiment, big data sampling program 112 leverages a distributed computing environment for dividing the set of big data into the multiple smaller data blocks. To achieve better accuracy, big data sampling program 112 utilizes a couple strategies for dividing the set of big data that are based on attributes of the set of big data: (1) for data with a sequence (e.g., time series data), divide the data equally based on the sequence variable, such as time, date, or ID, and (2) for data without a sequence, divide the data using random sampling or based on an election of a certain variable (e.g., age group, region, etc.), group the data with similar attributes together.

In step 220, for each smaller data block, big data sampling program 112 calculates an original value for a data distribution of the respective smaller data block. In an embodiment, big data sampling program 112 calculates an original value for the data distribution of each smaller data block to be used as a baseline for later comparison after samplings are done on each smaller data block. In an embodiment, big data sampling program 112 performs this calculation using known algorithms for calculating data distribution, such as parametric methods, plotting position, and regression analysis. In an embodiment, responsive to dividing the set of big data into multiple different smaller data blocks, big data sampling program 112 calculates an original value for the data distribution of each smaller data block.

In step 230, for each smaller data block, big data sampling program 112 runs multiple different sampling methods against the respective smaller data block to produce multiple different sets of sample data. In an embodiment, for each smaller data block, big data sampling program 112 runs multiple (i.e., at least two) different sampling methods against the respective smaller data block to produce multiple (i.e., at least two and equal to the number of sampling methods used) different sets of sample data. Types of data sampling methods that big data sampling program 112 may use include, but are not limited to, random sampling, systematic sampling, stratified sampling, and cluster sampling. In one embodiment, big data sampling program 112 runs each different sampling method against the respective data block at the same time. In another embodiment, big data sampling program 112 runs each different sampling method against the respective data block one sampling method at a time.

In step 240, for each smaller data block, big data sampling program 112 calculates respective sampling values for the data distribution of each set of sample data output from each different sampling method. In an embodiment, for each data block, responsive to producing the multiple different sets of sample data from running the multiple different sampling methods, big data sampling program 112 calculates respective sampling values for the data distribution of each set of sample data output from each different sampling method.

In step 250, for each smaller data block, big data sampling program 112 selects a set of sample data of the multiple different sets of sample data that has the respective sampling value for the data distribution that is closest to the original value of the data distribution of the respective smaller data block. In an embodiment, for each smaller data block, big data sampling program 112 determines which sampling value is the closest to the original value by comparing the respective sampling values for the data distribution of each set of sample data output from each different sampling method to the original value for the data distribution of the respective smaller data block. Based on the variable type, for each data block, big data sampling program 112 compares the data distribution between the original value and the respective sampling values. In an embodiment, responsive to calculating the respective sampling values for the data distribution of each set of sample data output from each different sampling method, automatically selecting the one set of sample data of the multiple different sets of sample data that has the respective sampling value for the data distribution that is closest to the original value for the data distribution of the respective smaller data block.

In step 260, big data sampling program 112 merges each selected set of sample data to form a final set of sample data. In an embodiment, responsive to, for each smaller data block, selecting the set of sample data that had the most similar sampling value for the data distribution to the original value for the data distribution of the respective data block, big data sampling program 112 merges each selected set of sample data from each data block to form one final set of sample data to be used as sample data of the original set of big data. Since the respective sets of sample data with the closest data distribution were selected for each smaller data block, the final set of sample data is the most representative set of sample data for the original set of big data as the closer to data distribution of the sample data is to the original set of big data, the more representative the sample data is of the original set of big data.

FIG. 3 is a block diagram 300 illustrating how an example big data set is processed by the big data sampling program, in accordance with an embodiment of the present invention. In the example shown, an original set of big data with, e.g., 100 million records is divided by big data sampling program 112 into four smaller data blocks shown as data block 1, data block 2, data block 3, and data block 4. Then, for each data block, big data sampling program 112 runs three different sampling methods to produce three different sets of sample data. Then, big data sampling program 112 selects the set of sample data out of the three sets of sample data for each data block that had the closest data distribution to that of the data block. As depicted, big data sampling program 112 selected sample data from using sampling method 3 for data block 1, sample data from using sampling method 2 for data block 2, sample data from sampling method 1 for data block 3, and sample data from using sampling method 3 for data block 4. Each of these selected sets of sample data are then merged into one final set of sample data by big data sampling program 112.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

In FIG. 4, computing environment 400 contains an example of an environment for the execution of at least some of the computer code involved in performing the inventive methods, such as big data sampling program 112. In addition to block 416, computing environment 400 includes, for example, computer 401, wide area network (WAN) 402, end user device (EUD) 403, remote server 404, public cloud 405, and private cloud 406. In this embodiment, computer 401 includes processor set 410 (including processing circuitry 420 and cache 421), communication fabric 411, volatile memory 412, persistent storage 413 (including operating system 422 and block 416, as identified above), peripheral device set 414 (including user interface (UI) device set 423, storage 424, and Internet of Things (IOT) sensor set 425), and network module 415. Remote server 404 includes remote database 430. Public cloud 405 includes gateway 440, cloud orchestration module 441, host physical machine set 442, virtual machine set 443, and container set 444.

Computer 401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 430. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically computer 401, to keep the presentation as simple as possible. Computer 401 may be located in a cloud, even though it is not shown in a cloud in FIG. 4. On the other hand, computer 401 is not required to be in a cloud except to any extent as may be affirmatively indicated.

Processors set 410 includes one, or more, computer processors of any type now known or to be developed in the future. Processing circuitry 420 may be distributed over multiple packages, for example, multiple, coordinated integrated circuit chips. Processing circuitry 420 may implement multiple processor threads and/or multiple processor cores. Cache 421 is memory that is located in the processor chip package(s) and is typically used for data or code that should be available for rapid access by the threads or cores running on processor set 410. Cache memories are typically organized into multiple levels depending upon relative proximity to the processing circuitry. Alternatively, some, or all, of the cache for the processor set may be located “off chip.” In some computing environments, processor set 410 may be designed for working with qubits and performing quantum computing.

Computer readable program instructions are typically loaded onto computer 401 to cause a series of operational steps to be performed by processor set 410 of computer 401 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 421 and the other storage media discussed below. The program instructions, and associated data, are accessed by processor set 410 to control and direct performance of the inventive methods. In computing environment 400, at least some of the instructions for performing the inventive methods may be stored in block 416 in persistent storage 413.

Communication fabric 411 is the signal conduction path that allows the various components of computer 401 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 412 is any type of volatile memory now known or to be developed in the future. Examples include dynamic type random access memory (RAM) or static type RAM. Typically, volatile memory 412 is characterized by random access, but this is not required unless affirmatively indicated. In computer 401, the volatile memory 412 is located in a single package and is internal to computer 401, but, alternatively or additionally, the volatile memory may be distributed over multiple packages and/or located externally with respect to computer 401.

Persistent storage 413 is any form of non-volatile storage for computers that is now known or to be developed in the future. The non-volatility of this storage means that the stored data is maintained regardless of whether power is being supplied to computer 401 and/or directly to persistent storage 413. Persistent storage 413 may be a read only memory (ROM), but typically at least a portion of the persistent storage allows writing of data, deletion of data and re-writing of data. Some familiar forms of persistent storage include magnetic disks and solid state storage devices. Operating system 422 may take several forms, such as various known proprietary operating systems or open source Portable Operating System Interface-type operating systems that employ a kernel. The code included in block 416 typically includes at least some of the computer code involved in performing the inventive methods.

Peripheral device set 414 includes the set of peripheral devices of computer 401. Data communication connections between the peripheral devices and the other components of computer 401 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 423 may include components such as a display screen, speaker, microphone, wearable devices (such as goggles and smart watches), keyboard, mouse, printer, touchpad, game controllers, and haptic devices. Storage 424 is external storage, such as an external hard drive, or insertable storage, such as an SD card. Storage 424 may be persistent and/or volatile. In some embodiments, storage 424 may take the form of a quantum computing storage device for storing data in the form of qubits. In embodiments where computer 401 is required to have a large amount of storage (for example, where computer 401 locally stores and manages a large database) then this storage may be provided by peripheral storage devices designed for storing very large amounts of data, such as a storage area network (SAN) that is shared by multiple, geographically distributed computers. IoT sensor set 425 is made up of sensors that can be used in Internet of Things applications. For example, one sensor may be a thermometer and another sensor may be a motion detector.

Network module 415 is the collection of computer software, hardware, and firmware that allows computer 401 to communicate with other computers through WAN 402. Network module 415 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 415 are performed on the same physical hardware device. In other embodiments (for example, embodiments that utilize software-defined networking (SDN)), the control functions and the forwarding functions of network module 415 are performed on physically separate devices, such that the control functions manage several different network hardware devices. Computer readable program instructions for performing the inventive methods can typically be downloaded to computer 401 from an external computer or external storage device through a network adapter card or network interface included in network module 415.

WAN 402 is any wide area network (for example, the internet) capable of communicating computer data over non-local distances by any technology for communicating computer data, now known or to be developed in the future. In some embodiments, the WAN 402 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 403 is any computer system that is used and controlled by an end user (for example, a customer of an enterprise that operates computer 401) and may take any of the forms discussed above in connection with computer 401. EUD 403 typically receives helpful and useful data from the operations of computer 401. For example, in a hypothetical case where computer 401 is designed to provide a recommendation to an end user, this recommendation would typically be communicated from network module 415 of computer 401 through WAN 402 to EUD 403. In this way. EUD 403 can display, or otherwise present, the recommendation to an end user. In some embodiments, EUD 403 may be a client device, such as thin client, heavy client, mainframe computer, desktop computer and so on.

Remote server 404 is any computer system that serves at least some data and/or functionality to computer 401. Remote server 404 may be controlled and used by the same entity that operates computer 401. Remote server 404 represents the machine(s) that collect and store helpful and useful data for use by other computers, such as computer 401. For example, in a hypothetical case where computer 401 is designed and programmed to provide a recommendation based on historical data, then this historical data may be provided to computer 401 from remote database 430 of remote server 404.

Public cloud 405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 405 is performed by the computer hardware and/or software of cloud orchestration module 441. The computing resources provided by public cloud 405 are typically implemented by virtual computing environments that run on various computers making up the computers of host physical machine set 442, which is the universe of physical computers in and/or available to public cloud 405. The virtual computing environments (VCEs) typically take the form of virtual machines from virtual machine set 443 and/or containers from container set 444. It is understood that these VCEs may be stored as images and may be transferred among and between the various physical machine hosts, either as images or after instantiation of the VCE. Cloud orchestration module 441 manages the transfer and storage of images, deploys new instantiations of VCEs and manages active instantiations of VCE deployments. Gateway 440 is the collection of computer software, hardware, and firmware that allows public cloud 405 to communicate through WAN 402.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 406 is similar to public cloud 405, except that the computing resources are only available for use by a single enterprise. While private cloud 406 is depicted as being in communication with WAN 402, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 405 and private cloud 406 are both part of a larger hybrid cloud.

What is claimed is:

1. A computer-implemented method comprising:
dividing, by one or more processors, a set of data into at least two smaller data blocks;
for each of the at least two smaller data blocks:
calculating, by the one or more processors, an original value for a data distribution of a respective smaller data block;
running, by the one or more processors, at least two different sampling methods against the respective smaller data block to produce at least two different sets of sample data for the respective smaller data block;
calculating, by the one or more processors, respective sampling values for the data distribution of each set of sample data of the at least two different sets of sample data; and
selecting, by the one or more processors, a set of sample data of the at least two different sets of sample data that has the respective sampling value that is closest to the original value for the respective smaller data block; and
merging, by the one or more processors, each selected set of sample data for each smaller data block to form a final set of sample data.

2. The computer-implemented method of claim 1, where the at least two smaller data blocks are each equal in size or different in size based on computing resources.

3. The computer-implemented method of claim 1, wherein the set of data has a sequence and a sequence variable; and wherein dividing the set of data into the at least two smaller data blocks comprises:
dividing, by the one or more processors, the set of data equally based on the sequence variable.

4. The computer-implemented method of claim 1, wherein the set of data has no sequence; and wherein dividing the set of data into the at least two smaller data blocks comprises:
dividing, by the one or more processors, the set of data using random sampling or based on an election of a certain variable.

5. The computer-implemented method of claim 1, wherein running the at least two different sampling methods involves running the at least two different sample methods against the respective smaller data block at a same time.

6. The computer-implemented method of claim 1, wherein running the at least two different sampling methods involves running the at least two different sample methods against the respective smaller data block one at a time.

7. The computer-implemented method of claim 1, wherein selecting the set of sample data of the at least two different sets of sample data that has the respective sampling value that is closest to the original value for the respective smaller data block is based on comparing the respective sampling values for the data distribution of each set of sample data output from each different sampling method to the original value for the data distribution of the respective smaller data block.

8. The computer-implemented method of claim 1, wherein the method is implemented using a distributed computing environment.

9. A computer program product comprising:
one or more computer readable storage media and program instructions collectively stored on the one or more computer readable storage media, the stored program instructions comprising:
program instructions to divide a set of data into at least two smaller data blocks;
for each of the at least two smaller data blocks:
program instructions to calculate an original value for a data distribution of a respective smaller data block;
program instructions to run at least two different sampling methods against the respective smaller data block to produce at least two different sets of sample data for the respective smaller data block;
program instructions to calculate respective sampling values for the data distribution of each set of sample data of the at least two different sets of sample data; and
program instructions to select a set of sample data of the at least two different sets of sample data that has the respective sampling value that is closest to the original value for the respective smaller data block; and
program instructions to merge each selected set of sample data for each smaller data block to form a final set of sample data.

10. The computer program product of claim 9, where the at least two smaller data blocks are each equal in size or different in size based on computing resources.

11. The computer program product of claim 9, wherein the set of data has a sequence and a sequence variable; and wherein the program instructions to divide the set of data into the at least two smaller data blocks comprise:
program instructions to divide the set of data equally based on the sequence variable.

12. The computer program product of claim 9, wherein the set of data has no sequence; and wherein the program instructions to divide the set of data into the at least two smaller data blocks comprise:
program instructions to divide the set of data using random sampling or based on an election of a certain variable.

13. The computer program product of claim 9, wherein the program instructions to run the at least two different sampling methods include program instructions to run the at least two different sample methods against the respective smaller data block at a same time.

14. The computer program product of claim 9, wherein the program instructions to select the set of sample data of the at least two different sets of sample data that has the respective sampling value that is closest to the original value for the respective smaller data block is based on comparing the respective sampling values for the data distribution of each set of sample data output from each different sampling method to the original value for the data distribution of the respective smaller data block.

15. The computer program product of claim 9, wherein the method is implemented using a distributed computing environment.

16. A computer system comprising:
one or more computer processors;
one or more computer readable storage media;
program instructions collectively stored on the one or more computer readable storage media for execution by at least one of the one or more computer processors, the stored program instructions comprising:
program instructions to divide a set of data into at least two smaller data blocks;
for each of the at least two smaller data blocks:
program instructions to calculate an original value for a data distribution of a respective smaller data block;
program instructions to run at least two different sampling methods against the respective smaller data block to produce at least two different sets of sample data for the respective smaller data block;
program instructions to calculate respective sampling values for the data distribution of each set of sample data of the at least two different sets of sample data; and
program instructions to select a set of sample data of the at least two different sets of sample data that has the respective sampling value that is closest to the original value for the respective smaller data block; and
program instructions to merge each selected set of sample data for each smaller data block to form a final set of sample data.

17. The computer system of claim 16, wherein the set of data has a sequence and a sequence variable; and wherein the program instructions to divide the set of data into the at least two smaller data blocks comprise:
program instructions to divide the set of data equally based on the sequence variable.

18. The computer system of claim 16, wherein the set of data has no sequence; and wherein the program instructions to divide the set of data into the at least two smaller data blocks comprise:
program instructions to divide the set of data using random sampling or based on an election of a certain variable.

19. The computer system of claim 16, wherein the program instructions to run the at least two different sampling methods include program instructions to run the at least two different sample methods against the respective smaller data block at a same time.

20. The computer system of claim 16, wherein the program instructions to select the set of sample data of the at least two different sets of sample data that has the respective sampling value that is closest to the original value for the respective smaller data block is based on comparing the respective sampling values for the data distribution of each set of sample data output from each different sampling method to the original value for the data distribution of the respective smaller data block.
